(19) United States
(12) Patent Application Publication
(10) Pub. No.: US 2022/0185718 A1
(43) Pub. Date: Jun. 16, 2022

(54) CONVEYING SHEETS OF GLASS USING SHAPED ROLLERS

(71) Applicant: SAINT-GOBAIN GLASS FRANCE, COURBEVOIE (FR)

(72) Inventors: Romain RENAUD, PARIS (FR); Robert LAGNEAUX, ATTICHY (FR)

(21) Appl. No.: 17/441,075

(22) PCT Filed: Mar. 25, 2020
(86) PCT No.: PCT/EP2020/058430

§ 371 Date: Sep. 20, 2021

(30) Foreign Application Priority Data
Mar. 29, 2019 (FR) FR1903319

(51) Int. Cl. C03B 35/16; C03B 23/033

(52) U.S. Cl. CPC C03B 35/161; C03B 23/033

(57) ABSTRACT

A roller for conveying sheets of glass, includes at its surface a conveying zone for the sheets of glass, the roller including a straight axis of revolution, the conveying zone forming a curved surface of revolution about the axis of revolution, the roller being asymmetric on either side of its, minimum or maximum, extreme diameter. A plurality of the rollers can also serve to bend running sheets of glass.

The invention relates to a curved roller for conveying and, if necessary, bending sheets of glass, and to a device comprising same, said roller being of the type having a straight axis of rotation and a curved surface of revolution.

The roller according to the invention is more particularly intended to be part of a set of rollers that form a conveying bed for conveying sheets of glass running one after another. The roller can also serve to bend sheets of glass heated to their deformation temperature. For this type of bending, the roller is advantageously associated with another roller of the same type but of complementary shape, this pair of rollers being able to be known as a “diabolo/barrel” or “diabolo/spindle”, the sheets being bent on passing therebetween. If one of the rollers of a pair of bending rollers is of the diabolo type, the other one, which is complementary thereto, is necessarily of the barrel (or spindle) type and vice versa.

WO2005047198 discloses the bending of sheets of glass running on a shaping bed made up of rollers for advancing them, said rollers being disposed on a path with a profile in the shape of a circular arc, the sheets being bent in their advancing direction.

WO2014053776 discloses a roller for driving sheets of glass, comprising a metal rod preformed with a curved profile along its length and a flexible sheath that can turn about the rod. The shaped metal rod does not turn and it is the flexible sheath turning about said rod that turns and drives the sheets of glass.

EP0346198 and EP1533280 disclose pairs of rollers of the diabolo/barrel type.

The roller according to the invention belongs to the category of rollers having a straight axis of revolution and a curved surface of revolution. Sheets of glass can be conveyed and, where necessary, bent by contact with this roller in its conveying zone.

According to the prior art, the shape given to this type of roller is always symmetric with respect to its middle, and it has never been sought nor desired to modify this symmetric shape. In order to produce such a roller, a block of metal is machined by being rotated about its axis on a machining lathe.

The bending of sheets of glass by curving between rollers is a particularly rapid and economical method that is often used to produce curvatures that are simple, symmetric and shallow, such as for side windows of motor vehicle glazing units. The bending of panes of glass into more complex shapes is generally realized by different methods such as press-bending, which is otherwise much more expensive to implement.

The tolerance on the shapes of glass panes is becoming increasingly tight. It has been found that when it is sought to symmetrically bend sheets of glass running on rollers having a symmetric shape with respect to their middle, the glass finally obtained could now depart from acceptable tolerances on account of a lack of symmetry of the bend with respect to the vertical plane of symmetry passing through the middle of the rollers. This defect is attributed to a lack of uniformity in the temperature of the glass resulting from a lack of symmetry of the heating of the glass in the heating furnace used before bending. This defect also exists when it is sought to bend two sheets of glass running side by side on the bed of rollers, said two sheets being intended for example to be fitted to the two lateral sides of a motor vehicle: a difference in the bent shapes of the two sheets has been observed in spite of the simultaneous bending thereof by symmetric tools intended to give them symmetric shapes with respect to the middle of the roller. The cause of this problem is also attributed to a lack of uniformity of the heating of the two sheets passing side by side through the furnace. Finally, since the shapes of motor vehicle windows are becoming increasingly more complex, it is now also sought to produce windows that are not symmetric with respect to their conveying direction while they are being bent, using a method that is rapid and inexpensive.

The invention provides a solution to the abovementioned problems. The invention relates to a roller for conveying sheets of glass, comprising at its surface a conveying zone for the sheets of glass, said roller comprising a straight axis of revolution, the conveying zone forming a curved surface of revolution about said axis of revolution, said roller being asymmetric on either side of its, minimum or maximum, extreme diameter. The roller is of the diabolo or barrel type intended to be part of a set of rollers forming a conveying bed for sheets of glass at a temperature greater than 400° C. The roller is asymmetric on either side of its extreme diameter, that is to say of its minimum diameter for a roller of the diabolo type or of its maximum diameter for a roller of the barrel type, and the diameter of the roller varies uniformly on either side of its extreme diameter.

The surface of revolution of the roller can be considered to be a series of circles that are parallel and orthogonal to the axis of the roller, the centers of said circles being located on said axis. The extreme diameter of the roller is at a minimum or maximum and corresponds to that of the circle of, minimum or maximum, extreme diameter.

The form of the generatrix of the surface of revolution is curved, meaning that the roller does not have a constant diameter along its axis. It is also asymmetric on either side of the extreme diameter of the roller.

The roller according to the invention can thus comprise a recess along its length, as for a roller of the “diabolo” type, or a boss along its length, as for a roller of the “barrel” type.

On either side of its extreme diameter, the diameter of the roller varies generally uniformly along the axis of the roller in the direction of one of its ends. The extreme diameter is not at one end of the conveying zone of the roller. Therefore, the conveying zone continues on either side of the extreme diameter. The roller comprises a useful zone on either side of its extreme diameter that comes into contact with the sheets of glass, the ratio of the axis lengths corresponding to the two sides of the conveying zone on either side of the extreme diameter generally being in the range from 0.25 to 4, and more generally from 0.5 to 2, and even more generally from 0.8 to 1.2. The roller generally has only one extreme diameter.

The invention also relates to a device for conveying sheets of glass running one after another, comprising at least one roller according to the invention, which is able to turn about its axis. The roller according to the invention is able to be driven in rotation about its axis by a motorized system. Generally, it is sufficient to drive the roller at one of its sides, its other side generally rotating freely.

The conveying zone is the useful zone of the roller that is able to convey sheets of glass. The extreme diameter of the roller is in the conveying zone. The roller has been machined so as to have an asymmetric shape with respect to the plane P that is orthogonal to its axis and comprises this (minimum or maximum) extreme diameter. The roller is generally machined by turning a solid metal cylinder. Thus, the roller is generally made of metal, such as steel. The extreme diameter can be at the middle of the axis length corresponding to the conveying zone. This does not have to be the case, the axis length corresponding to the conveying zone then being longer on one side of the extreme diameter than the axis length on the other side.

The prior art rollers of this type have a symmetric shape on either side of their extreme diameter situated generally at their middle, the generatrix of their surface of revolution being circular or almost circular. In the scope of the present invention, the shape of the generatrix (contained in any plane containing the axis of the roller) is more like a comma, with smaller radii of curvature on one side of the extreme diameter and larger radii of curvature on the other side of the extreme diameter. In use, in order to convey and optionally bend sheets of glass, the axis of the roller is generally horizontal.

The roller according to the invention is generally part of a bed of rollers that is able to come into contact with the sheets of glass running one after another. The roller can thus be part of a set of substantially parallel side-by-side rollers of the same type. Thus, the bed of rollers is made up of a set of substantially parallel rollers. Thus, the device according to the invention can comprise a plurality of said rollers, which are mutually parallel, forming a bed of rollers in contact with which the sheets of glass can be conveyed one after another. The bed can be a lower bed on which the sheets rest and are conveyed. The bed can also be an upper bed under which the sheets are conveyed. In the latter case, the device also comprises a lower bed and the sheets run and are generally bent between the lower bed and the upper bed. The rollers of one and the same bed are able to come into contact with a single face of the sheets of glass.

In addition to conveying sheets of glass, the roller according to the invention can also serve to bend them. In particular, if the sheets are at their deformation temperature, the sheets of glass can bend by sagging under their own weight as they run over the bed of rollers.

It is also possible to form a pair of parallel rollers between which the glass is conveyed and bent as it passes between the rollers. To this end, the device may comprise a first roller according to the invention and a second roller of this type (“of this type” meaning that it has the same makeup as the first, in other words “comprising a straight axis of revolution, the conveying zone forming a curved surface of revolution about said axis of revolution, said roller being asymmetric on either side of its extreme diameter”), these two rollers forming a pair of rollers, their surfaces of revolution being complementary and these two rollers exhibiting a constant spacing between one another along the entire length of the conveying zone. This spacing corresponds to the thickness of the sheets of glass to be bent. The sheets are bent on passing between the two rollers of the pair of rollers. The axes of these two rollers are mutually parallel. The plane containing the axes of the two rollers is perpendicular to the conveying direction of the sheets. In particular, these two rollers can be one above the other. Generally, the axis of the first roller is at a lower level than the axis of the second roller, the extreme diameter of the first roller being a minimum value and the extreme diameter of the second roller being a maximum value. On passing between the rollers of such a pair of bending rollers, the glass, heated to its deformation temperature, is bent in a transverse direction, that is to say orthogonal to the running direction of the glass, that is to say a direction parallel to the axis of the roller. Along this direction, the glass takes on the shape given by the shape of the generatrix of the surface of revolution of the roller.

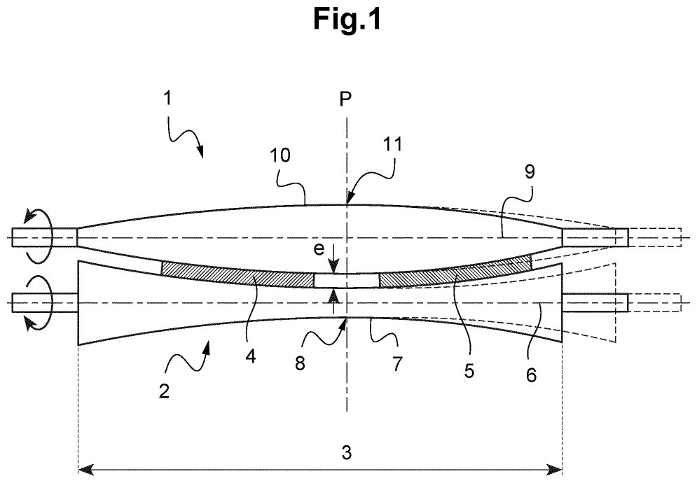

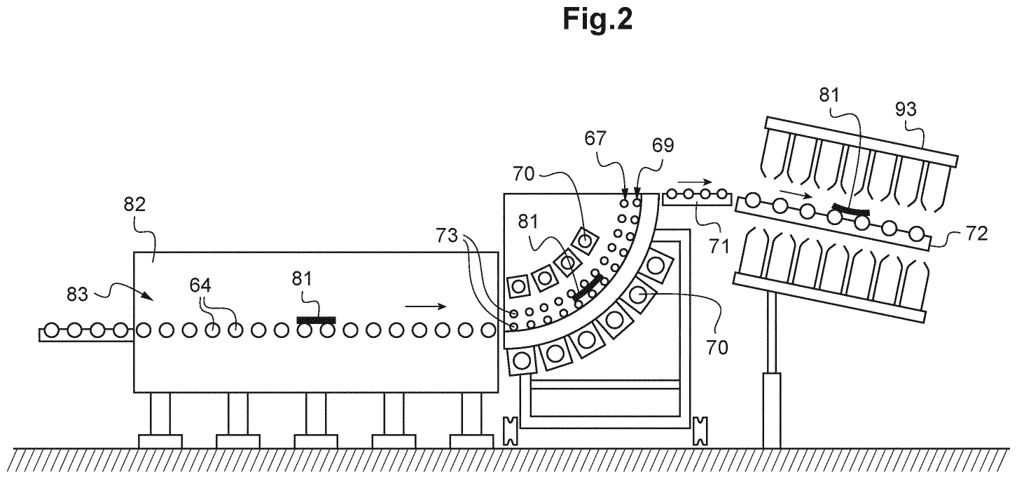

The bending device according to the invention can also confer a longitudinal bend on the sheets of glass, that is to say one in the running direction of the sheets of glass. To this end, it is possible to form, with juxtaposed rollers according to the invention, an upward or downward conveying bed in the form of a circular arc as seen from the side, and position, from the start of the circular arc, at least one roller of the same type above said bed (while having a shape complementary to that of the bed), parallel to a roller of the bed of rollers and maintaining, with said bed, a constant spacing along the entire length of the rollers, said spacing corresponding to the thickness of the sheets of glass to be bent. As they travel along the circular arc, in addition to their transverse bend (which, according to the invention, is not a circular arc), the sheets of glass then take on the circular arc shape in the longitudinal direction. Nozzles for blowing cooling air can blow air between the rollers from the start of the shaping of the glass in a first portion of the circular arc path. Air is generally blown after the first rollers in order to continue the cooling. This cooling is generally intended to effect heat strengthening resulting in particular in heat strengthened glass, also known as “semi-tempered”, or in thermally toughened glass. The principle of a device using two beds of rollers in the form of a circular arc as seen from the side in order to effect bending in the longitudinal conveying direction of the glass is described in particular in FIG. 2 of WO2014053776 or FIGS. 1 and 2 of WO2005047198.

Thus, the bending device according to the invention may comprise a plurality of pairs of rollers according to the invention, forming a bed of lower rollers and a bed of upper rollers for applying a bend to the sheets of glass passing between these two beds of rollers, said bend having at least one transverse direction perpendicular to the conveying direction of the sheets of glass. The beds of rollers can have an upward or downward curved profile in the conveying direction of the sheets of glass in order to also apply a longitudinal bend to the latter on passing between these two beds of rollers. The bending is thermal bending, this expression denoting hot bending of the glass at its softening point allowing its deformation, this being permanent after it returns to ambient temperature. It is therefore not cold bending, which is applied in the elastic range of the glass. The temperature of the glass during the thermal bending is in particular between 400 and 700° C.

The invention is useful in particular for conveying and, if necessary, bending sheets of glass with a temperature greater than 400° C., or even greater than 500° C., in particular between 400 and 700° C., and more particularly between 500 and 680° C. If the roller is intended to convey and/or bend sheets of glass at a temperature greater than 400° C., preferably, the roller is covered with a sleeve made of a material comprising refractory fibers (made of metal and/or ceramic) softening the contact with the glass.

In the context of the bending of sheets of glass, the sheets of glass are brought to their deformation temperature by being heated in a furnace. The roller according to the invention can in particular serve to convey the sheets of glass in the furnace. The bending of the sheets can be carried out after they leave the furnace, while they are still at the temperature allowing them to be bent. The roller according to the invention can therefore likewise be located outside the furnace in order to convey the sheets toward the bending device. The bending device can also comprise the roller according to the invention. In particular, for this bending, the sheets can pass over a bed of rollers, in the form of an upward or downward circular arc as already explained. The two rollers of a pair of bending rollers between which the glass passes can be of the roller type according to the invention.

The invention also relates to a method for conveying sheets of glass, comprising the conveying of sheets of glass running one after another in contact with and in the conveying zone of the roller of the device according to the invention.

A plurality of sheets of glass, in particular two or four or eight sheets of glass, can be conveyed and, if necessary, bent while running side by side. Note that “side by side” means that the sheets in question come into simultaneous contact with one and the same roller. In the case of two sheets running side by side, these may be two sheets that are each intended to be fitted to one side of the same motor vehicle. In particular, these two sheets of glass may be intended, upon being bent, to take on shapes that give them mirror symmetry with respect to one another (the mirror being vertical and passing through the middle of the vehicle for an observer positioned facing the front of the vehicle). In this case, the roller according to the invention is thus shaped in an asymmetric manner on either side of its extreme diameter, but with the two sheets of glass ultimately being formed so as to be symmetric with respect to one another. The asymmetry has the purpose of compensating a lack of symmetry of the heating installation. In the case of four sheets running side by side, these may be four sheets that are intended to be fitted in pairs to the two sides of the same motor vehicle. These two pairs of sheets of glass may be intended, upon being bent, to take on shapes exhibiting mirror symmetry in pairs (the mirror being vertical and passing through the middle of the vehicle for an observer positioned facing the front of the vehicle): two sheets on a first side of the motor vehicle (for example a “windshield quarter” and a “front quarter”) have, corresponding to them, exactly the same glazed elements on the other side of the vehicle but in mirror symmetry with respect to those intended for the first side. On the same principle, it is also possible to bend eight sheets running side by side, in order to be fitted to one and the same vehicle, four sheets being fitted to one side of the vehicle, the other four sheets being fitted to the other side of the vehicle. These eight sheets exhibit mirror symmetry in twos, forming two groups of four sheets, all the sheets of one and the same group passing on the same side of the extreme diameter. Thus, whether two or four or eight sheets are bent side by side, the sheets of glass, upon being bent, take on shapes that give them mirror symmetries, such that each sheet of a group passing over the roller on one side of the extreme diameter has, corresponding to it, a sheet of the other group that is symmetric thereto and passes over the roller on the other side of said extreme diameter. Thus, the sheets of glass form two groups situated on either side of the extreme diameter of the rollers, each sheet of a group having, corresponding to it, a sheet of the other group, these two sheets, upon bending, taking on symmetric shapes to one another with respect to the plane passing through the extreme diameter of the rollers.

After hot bending, the sheets can be heat strengthened by blowing cool air onto their surface. In particular, air can be blown onto the sheets of glass between the rollers of one and the same bed in order to heat strengthen the glass, in particular to thermally temper it. The device according to the invention may therefore comprise air blowing nozzles for blowing air between rollers of the same bed in order to carry out heat strengthening of the glass, in particular tempering.

FIG. 1 shows two rollers 1 and 2 according to the invention forming a pair of rollers for bending two sheets of glass 4 and 5 passing side by side in a conveying zone 3. The bottom roller 2 is of the “diabolo” type. This roller comprises a straight axis 6 and a surface of revolution 7. This surface of revolution comprises a circle, the center of which is on the axis and of minimum diameter comprising the point 8. The surface of revolution is asymmetric on either side of the plane P that is orthogonal to the axis of the roller and comprises this circle of said surface of revolution having a minimum extreme diameter. The top roller 3 is of the “barrel” type. This roller comprises a straight axis 9 and a surface of revolution 10. This surface of revolution comprises a circle of maximum diameter comprising the point 11. The surface of revolution of this roller is asymmetric on either side of the plane P that is orthogonal to the axis 9 of the roller and comprises this circle of maximum diameter. The plane P comprises both the circle of minimum diameter of the roller 2 and the circle of maximum diameter of the roller 1. These rollers have complementary shapes with respect to one another and their surfaces of revolution are at a distance from one another by a constant spacing over the entire conveying zone, this spacing being equal to the thickness e of a sheet of glass. The dashed lines on the right-hand side of the figure represent the shape that the surfaces of revolution of the two rollers would have toward the right if they were symmetric with respect to a plane P, which would then be located slightly farther to the right in the figure.

FIG. 2 is a schematic depiction in side view (transverse view) of a bending and tempering machine to which the invention more particularly applies. A sheet of glass runs through and is heated in a furnace, then passes through an upward shaping bed, and then, at the outlet, through a secondary cooling zone. The sheet of glass 81, which is initially flat, firstly crosses a heating zone 82 of a tunnel furnace (the arrow in the furnace indicates the conveying direction, which is also the longitudinal direction), through which it is carried on a horizontal conveyor 83 moved by a bed of straight motorized rollers 64 that are aligned in a plane. At the outlet of the temperature-raising furnace, the glass is at its deformation temperature, allowing the thermal bending thereof. The sheet of glass 81 then passes into a shaping zone comprising a bed of upper rollers 67 and a bed of lower rollers 69 that are mounted with an upward profile in the form of a circular arc in side view. The sheets of glass pass between the two rollers of pairs of rollers, said pairs being disposed one after another on the path of the sheets of glass. For most of the pairs of rollers, the axis of the first roller is at a lower level than the axis of the second roller. The running sheets of glass are squeezed and shaped between pairs 73 of rollers of these two beds of rollers. The bed of rollers 67 and the bed of rollers 69 thus form an upward shaping bed that conveys the sheet of glass 81 in the same direction as the conveyor 83. The sheets of glass 81 are bent, starting at the first pairs 73 of rollers, in the transverse direction as shown in FIG. 1, and in the longitudinal direction corresponding to the upward circular arc shape of the beds of rollers. This shaping is followed by cooling between the two beds of rollers, in particular tempering. To this end, nozzles blow cool air between the rollers onto the two faces of the sheets. These nozzles are connected to box structures 70 that supply them with the necessary air. The glass is thus fixed just after it has been bent. The air is blown starting at the first pairs of bending rollers. On leaving the shaping and tempering bed, the sheets of glass that have become rigid tip onto a conveyor 71. The sheets of glass 81 are then evacuated by a flat conveyor 72 that passes through a secondary cooling zone 93.

1. A roller, which is a diabolo roller or a barrel roller configured to be part of a set of rollers forming a conveying bed for sheets of glass at a temperature greater than 400° C., comprising at its surface a conveying zone for the sheets of glass, said roller comprising a straight axis of revolution, the conveying zone forming a curved surface of revolution about said axis of revolution, said roller being asymmetric on either side of its extreme diameter, the extreme diameter corresponding to a minimum diameter for the diabolo roller or the extreme diameter corresponding to a maximum diameter for the barrel roller, a diameter of the roller varying uniformly on either side of its extreme diameter.

2. The roller as claimed in claim 1, wherein a ratio of axis lengths corresponding to two sides of the conveying zone on either side of the extreme diameter is in the range from 0.25 to 4.

3. A device for conveying sheets of glass running one after another, comprising at least one roller of claim 1, which is configured to turn about its axis.

4. The device as claimed in claim 3, further comprising a plurality of said rollers, which are substantially mutually parallel, forming a bed of rollers that is configured to come into contact with one and a same face of the sheets of glass.

5. The device as claimed in claim 3, wherein the roller is a first roller, and wherein the device comprises a second one of said roller, the first and second rollers forming a pair of rollers, wherein surfaces of revolution of the first and second rollers are complementary and exhibit a constant spacing along an entire length of the conveying zone.

6. The device as claimed in claim 5, wherein the axis of the first roller is at a lower level than the axis of the second roller, and wherein the extreme diameter of the first roller is a minimum value, the extreme diameter of the second roller being a maximum value.

7. The device as claimed in claim 5, further comprising a plurality of said pair of rollers forming a bed of lower rollers and a bed of upper rollers for applying a bend to the sheets of glass passing between the beds of lower and upper rollers, said bend having at least one transverse direction perpendicular to a conveying direction of the sheets of glass.

8. The device as claimed in claim 7, wherein the beds of upper and lower rollers have an upward or downward curved profile in the conveying direction of the sheets of glass in order to also apply a longitudinal bend to the sheets of glass.

9. The device as claimed in claim 7, further comprising air blowing nozzles for blowing air between rollers of a same bed in order to carry out heat strengthening of the glass.

10. A method for conveying sheets of glass, comprising conveying sheets of glass running one after another by the device of claim 3.

11. The method as claimed in claim 10, wherein a plurality of sheets of glass are conveyed side by side.

12. The method as claimed in claim 10, wherein the device comprises a plurality of pairs of rollers such that, for each pair of rollers, surfaces of revolution of the rollers of said pair are complementary and exhibit a constant spacing along an entire length of the conveying zone, corresponding to a thickness of the sheets of glass, said pairs of rollers forming a bed of lower rollers and a bed of upper rollers, the sheets of glass being bent at a deformation temperature on passing between the lower and upper beds of rollers, said bend having at least one transverse direction perpendicular to the conveying direction of the sheets of glass.

13. The method as claimed in claim 12, wherein the lower and upper beds of rollers have an upward or downward curved profile in a conveying direction of the sheets of glass, the sheets of glass also being bent in a longitudinal direction on passing between the lower and upper beds of rollers.

14. The method as claimed in claim 12, wherein a plurality of sheets of glass are bent simultaneously side by side.

15. The method as claimed in claim 14, wherein the sheets of glass form two groups situated on either side of the extreme diameter of the rollers, each sheet of a group having, corresponding to it, a sheet of the other group, the two sheets, upon bending, taking on symmetric shapes to one another with respect to a plane passing through the extreme diameter of the rollers.

16. The method as claimed in claim 12, wherein, after bending, air is blown onto the sheets of glass between rollers of one and the same bed in order to heat strengthen the glass.

17. The roller as claimed in claim 2, wherein the ratio is from 0.8 to 1.2.

18. The device as claimed in claim 9, wherein the air blowing nozzles blow air between rollers to carry out tempering of the glass.

19. The method as claimed in claim 11, wherein the plurality of sheets of glass is two or four or eight sheets of glass.

20. The method as claimed in claim 12, wherein the deformation temperature is between 400 and 700° C.
